(19) United States
(12) Patent Application Publication
(10) Pub. No.: US 2024/0423238 A1
(43) Pub. Date: Dec. 26, 2024

(54) TEXTURED VEGETABLE PROTEIN

(71) Applicant: Evergrain International BV, Leuven (BE)

(72) Inventors: Sofie FREDERIX, Leuven (BE); Steffen MÜNCH, Leuven (BE)

(21) Appl. No.: 18/699,564

(22) PCT Filed: Oct. 7, 2022
(86) PCT No.: PCT/EP2022/077991

§ 371 Date: Apr. 8, 2024

(30) Foreign Application Priority Data
Oct. 7, 2021 (BE) BE2021/5782

(51) Int. Cl. A23J 3/22; A23J 3/16; A23J 3/18

(52) U.S. Cl. CPC A23J 3/227; A23J 3/16; A23J 3/18

(57) ABSTRACT

The present invention relates to a textured vegetable protein comprising high protein brewer's spent grain powder. The present invention also relates to a process for preparing the textured vegetable protein, to a meat analogue comprising the textured vegetable protein in hydrated form, to a process for preparing the meat analogue, and to a food product comprising the meat analogue.

### FIELD OF THE INVENTION

The present invention relates to a textured vegetable protein comprising high protein brewer's spent grain powder. The present invention also relates to a process for preparing the textured vegetable protein, to a meat analogue comprising the textured vegetable protein in hydrated form, to a process for preparing the meat analogue, and to a food product comprising the meat analogue.

### BACKGROUND

Demand for meat alternatives for human consumption has increased significantly in recent years and continues to grow. Reasons for this include greater awareness of the environmental impact of meat production and the desire for more sustainable sources of high quality protein, animal welfare concerns, and a general increased interest in reducing or eliminating meat from the diet.

Meat alternatives which seek to mimic the taste, texture and appearance of meat have been known for some time, and may be referred to as meat analogues. One well-known category of meat analogue is based on textured vegetable protein. Textured vegetable protein is produced from a mixture of protein and water by an extrusion process. The textured vegetable protein product is a dry product which can be rehydrated to provide a meat analogue, and such meat analogues are generally produced to resemble minced or ground meat. They may be used as a complete replacement for meat or they may be used as a partial replacement for meat, i.e. as a meat extender.

In general, it is necessary to use colouring agents in order to achieve the desired meat-like appearance when textured vegetable protein is used as the basis for meat analogues. It would be desirable if a more meat-like appearance could be achieved without, or with a reduced need for, additional colouring agents. Thus, an object of the present invention is to provide a textured vegetable protein with which a meat-like appearance can be achieved without, or with a reduced amount of, colouring agents.

One characteristic of meat that is particularly difficult to replicate from a sensory point of view is texture, particularly in terms of the characteristic “chew” of real meat. There is therefore a need for meat analogues that are better able to replicate meat in this regard. As such, an object of the present invention is to provide a meat analogue which better matches the texture of meat, particularly in terms of meat-like “chew”.

The protein used for the production of textured vegetable protein is generally soy protein. Reasons for this include the fact that soy protein provides meat-like characteristics when subjected to extrusion, and the fact that soy protein is a high quality or “complete” protein, i.e. a protein source that contains an adequate proportion of the nine amino acids essential for the human diet in digestible form.

Despite the benefits of soy protein in the production of textured vegetable protein, there is an increasing demand for alternatives. Reasons for this include concerns about the environmental impact of soybean production, particularly in terms of deforestation and clearance of other virgin land for soybean cultivation. Another object of the present invention is therefore to provide alternatives for soy and other legume-derived proteins in textured vegetable protein, while continuing to provide a high quality protein.

Brewer's spent grain (BSG) is the most abundant by-product generated in the beer-brewing process. This material comprises malt and grain husks obtained as a solid fraction after the mash filtration or lautering step. It is rich in nutrients, particularly protein and fibre.

In general, BSG is treated as a waste product and put to low value uses, in particular as an animal feed, or sent to landfill. More recently, attempts have been made to make better use of BSG, in particular to produce food components for human consumption. In this regard, WO 2021/028405 provides a process whereby BSG can be separated very effectively into high protein and high fibre fractions, each of which can be used as food components and thereby enhance the protein and/or fibre content of food products.

The possibility of using BSG as an ingredient in certain types of extruded product is known. Ainsworth et al., J. Food. Eng., 81, 2007, 702-709 investigated the possibility of including an amount of (unprocessed) BSG as a fibre source in chickpea-based extruded snacks, while WO 2018/050863 suggests that (processed) BSG can be included in pet food compositions that may be produced, inter alia, by extrusion. In both cases, protein is a minor component of the compositions contemplated for extrusion, and the compositions could not, therefore, be used to prepare a textured vegetable protein.

There remains a need for applications for BSG which reduce the amount of BSG sent to landfill and make better use of its nutrient content. Thus, a further object of the present invention is to provide a means for incorporating BSG in the human diet.

### SUMMARY OF THE INVENTION

The present invention provides a process for providing a textured vegetable protein comprising high protein brewer's spent grain powder. The present invention also relates to the textured vegetable protein comprising high protein brewer's spent grain powder, to a meat analogue comprising the textured vegetable protein in hydrated form, to a process for preparing the meat analogue, and to a food product comprising the meat analogue.

The present invention may be summarised by reference to the following numbered clauses:

1. A process for preparing a textured vegetable protein, wherein the process comprises extruding a mixture comprising a protein blend and water to produce a textured vegetable protein, wherein the protein blend comprises legume-derived protein and high protein brewer's spent grain powder, and wherein the high protein brewer's spent grain powder has a total protein content (% dry matter by weight) of at least 25% based on the total weight of the high protein brewer's spent grain powder.
2. The process according to Clause 1, wherein the mixture comprising the protein blend and water has a total protein content (% dry matter by weight) of at least 50%, preferably at least 55%, more preferably at least 60%.
3. The process according to Clause 1 or 2, wherein the mixture comprising the protein blend and water has a total dietary fibre content (% dry matter by weight) of at least 5%, preferably at least 8%.
4. The process according to any of Clauses 1 to 3, wherein the mixture comprising the protein blend and water consists essentially of, or consists of, the protein blend and water.
5. The process according to any preceding clause, wherein the high protein brewer's spent grain powder has a total protein content (% dry matter by weight) of at least 30% based on the total weight of the high protein brewer's spent grain powder.
6. The process according to any preceding clause, wherein the high protein brewer's spent grain powder has a total protein content (% dry matter by weight) of at least 33%, and a total dietary fibre content (% dry matter by weight) of greater than 35% and below 55%, based on the total weight of the high protein brewer's spent grain powder.
7. The process according to any of any preceding clause, wherein the legume-derived protein is a legume protein concentrate or a legume protein isolate.
8. The process according to any preceding clause, wherein the protein blend comprises legume-derived protein in an amount of from 20 to 90% by weight, preferably from 40 to 90% by weight, based on the total weight of the protein blend.
9. The process according to Clause 8, wherein the protein blend comprises legume-derived protein in an amount of from 55 to 90% by weight, preferably from 60 to 85% by weight, preferably from 75 to 85% by weight, based on the total weight of the protein blend.
10. The process according to any preceding clause, wherein the protein blend comprises high protein brewer's spent grain powder in an amount of from 10 to 80% by weight, preferably from 10 to 60% by weight, based on the total weight of the protein blend.
11. The process according to Clause 10, wherein the protein blend comprises high protein brewer's spent grain powder in an amount of from 10 to 45% by weight, preferably from 15 to 40% by weight, preferably from 15 to 25% by weight, based on the total weight of the protein blend.
12. The process according to any preceding clause, wherein the legume-derived protein is protein derived from one or more of beans, peas, chickpeas, lupins, lentils and peanuts, and is preferably derived from beans and/or peas.
13. The process according to Clause 12, wherein the legume-derived protein is soy bean protein, pea protein, or a mixture of soy bean protein and pea protein.
14. The process according to Clause 13, wherein the soy bean protein is a soy bean protein concentrate and/or wherein the pea protein is a pea protein isolate.
15. The process according to any preceding clause, wherein the protein blend further comprises vital wheat gluten.
16. The process according to Clause 15, wherein the protein blend comprises vital wheat gluten in an amount of up to 40% by weight, preferably from 10 to 40% by weight, preferably from 10 to 30% by weight, based on the total weight of the protein blend.
17. The process according to any preceding clause, wherein the protein blend has a Protein Digestibility Corrected Amino Acid Score (PDCAAS) of at least 0.7, preferably at least 0.8, preferably at least 0.9.
18. The process according to any preceding clause, wherein the textured vegetable protein has a water content of from 2 to 10% by weight.
19. The process according to any preceding clause, wherein the extruding comprises low moisture extrusion cooking in an extruder.
20. The process according to Clause 19, wherein the extruder is a twin-screw extruder.
21. The process according to any preceding clause, wherein the extruding is carried out in an extruder under conditions of high temperature, pressure and shear effective to restructure protein and produce a fibrous, insoluble and porous protein network.
22. The process according to any preceding clause, wherein the extruding comprises the following steps:
a) forming a mixture comprising the protein blend and water;
b) heating the mixture to above the denaturation temperature of the proteins present in the mixture;
c) applying shear and pressure to the mixture in an extruder to form a fibrous protein network;
d) forcing the mixture through a die to form the textured vegetable protein;
e) optionally, cutting the textured vegetable protein; and
f) optionally, drying the textured vegetable protein.
   23. The process according to any of Clauses 19 to 22, wherein a specific mechanical energy (SME) of at least 50 W*h/kg is applied to the mixture in the extruder.
   24. The process according to Clause 22 or 23, wherein steps a) and b) are conducted in the extruder, in a preconditioner, or in a combination of the preconditioner and the extruder.
   25. The process according to any of Clauses 22 to 24, wherein water is added to the mixture in step a) and in steps b) and/or c).
   26. The process according to any preceding clause, wherein the extruding comprises adding the protein blend in a total amount of from 60% to 85% by weight and adding water in a total amount of from 15 to 40% by weight based on the total weight of the mixture comprising the protein blend and water.
   27. A textured vegetable protein comprising a protein blend and water, wherein the protein blend comprises legume-derived protein and high protein brewer's spent grain powder, and wherein the high protein brewer's spent grain powder has a total protein content (% dry matter by weight) of at least 25% based on the total weight of the high protein brewer's spent grain powder.
   28. The textured vegetable protein according to Clause 27, wherein the protein blend is a protein blend as defined in any one of Clauses 5 to 17.
   29. A textured vegetable protein prepared by a process according to any one of Clauses 1 to 26.
   30. The textured vegetable protein according to any one of Clauses 27 to 29, wherein the textured vegetable protein has a total protein content (% dry matter by weight) of at least 50%, preferably at least 55%, more preferably at least 60%.
   31. The textured vegetable protein according to any one of Clauses 27 to 30, wherein the textured vegetable protein has a total dietary fibre content (% dry matter by weight) of at least 5%, preferably at least 8%.
   32. The textured vegetable protein according to any one of Clauses 27 to 31, wherein the textured vegetable protein has a water content of from 2 to 10% by weight.
   33. A hydrated textured vegetable protein, wherein the textured vegetable protein is the textured vegetable protein according to any one of Clauses 27 to 32.
   34. The hydrated textured vegetable protein according to Clause 33, wherein the hydrated textured vegetable protein has a water content of from 40 to 80%, preferably from 60 to 80% by weight.
   35. A meat analogue comprising the hydrated textured vegetable protein according to Clause 33 or 34.
   36. The meat analogue according to Clause 35, wherein the meat analogue further comprises one or more ingredients of animal origin.
   37. The meat analogue according to Clause 35, wherein the meat analogue does not include any ingredients of animal origin.
   38. The meat analogue according to any one of Clauses 35 to 37, wherein the meat analogue further comprises one or more further ingredients selected from the group consisting of binders, seasonings, herbs, spices, fats, natural and/or synthetic sweeteners, natural and/or synthetic flavourings, and natural and/or synthetic preservatives.
   39. The meat analogue according to any one of Clauses 35 to 38, wherein the meat analogue is a ground meat analogue.
   40. A process for preparing a meat analogue, comprising hydrating a textured vegetable protein according to any one of Clauses 27 to 32 to provide a hydrated textured vegetable protein and, optionally, combining the hydrated textured vegetable protein with one or more ingredients of animal origin and/or with one or more further ingredients as defined in Clause 38.
   41. The process according to Clause 40, wherein the textured vegetable protein is hydrated in an aqueous solution or suspension comprising one or more further ingredients as defined in Clause 38.
   42. A food product comprising a meat analogue according to any one of Clauses 35 to 39.
   43. The food product according to Clause 42, wherein the food product is selected from the group consisting of burgers, sausages, meat balls, nuggets, pizza toppings, sauces, stews, and jerky.
   44. The food product according to Clause 42 or Clause 43, wherein the food product comprises meat and the meat analogue acts as a meat extender.
   45. The food product according to Clause 42 or Clause 43, wherein the food product does not include any ingredients of animal origin.

### DETAILED DESCRIPTION

A first aspect of the present invention provides a process for preparing a textured vegetable protein, wherein the process comprises extruding a mixture comprising a protein blend and water to produce a textured vegetable protein, wherein the protein blend comprises legume-derived protein and high protein brewer's spent grain powder, and wherein the high protein brewer's spent grain powder has a total protein content (% dry matter by weight) of at least 25% based on the total weight of the high protein brewer's spent grain powder

### Mixture Comprising a Protein Blend and Water:

The mixture comprising the protein blend and water preferably has a total protein content (% dry matter by weight) of at least 50%, preferably at least 55%, and more preferably at least 60% (as determined by the Kjeldahl method using a conversion factor of 6.25). For example, the total protein content (% dry matter by weight) may be in the range of from 50% to 90%, for example 50, 55, 60, 65, 70, 75, 80, 85 or 90%, or any intermediate value.

The mixture comprising the protein blend and water preferably has a total dietary fibre content (% dry matter by weight) is typically at least 5%, for example at least 8%, at least 15%, at least 20%, at least 25%, at least 30%, or any intermediate value. For example, the total dietary fibre content (% dry matter by weight) may be in the range of from 5 to 25%, for example 5, 8, 10, 15, 20 or 25%, or any intermediate value.

The mixture comprising the protein blend and water may consist essentially of, or consist of, the protein blend and water.

### Textured Vegetable Protein:

The term “textured vegetable protein” has a well-known meaning in the art, and is described in textbooks, such as Chapter 15 (Texturized vegetable proteins) of the Handbook of Food Proteins (M. N. Riaz, Woodhead Publishing, 2011, Pages 395-418), and in review papers, such as Bakhsh et al., “Quality Characteristics of Meat Analogs through the Incorporation of Textured Vegetable Protein: A Systematic Review”, Foods 2022, 11, 1242. The term “texturised vegetable protein” is also used in the art with the same meaning.

According to its well-known meaning, the term “textured vegetable protein” (often abbreviated to “TVP”) refers to a product comprising extruded vegetable protein, in particular (low moisture) extrusion cooked vegetable protein. The extrusion process parameters are selected such as to subject the vegetable protein to the conditions required for forming a textured vegetable protein, namely conditions of high temperature, pressure and shear. These conditions restructure the vegetable protein to produce a fibrous, insoluble and porous protein network, which forms the basis for the texture of the final product. On exiting the extruder, a sudden drop in pressure causes rapid expansion, and this expanded product is then dried to provide the textured vegetable protein.

Textured vegetable protein is characterised by a fibrous, insoluble and porous protein network that is produced during the extrusion cooking process, i.e. it is a (low moisture) extrusion cooked vegetable protein comprising a fibrous, insoluble and porous protein network. In order to obtain this proteinaceous fiber structure, the ingredients subject to extrusion cooking (i.e. the extrusion mass) must have a high protein content, and the extrusion parameters must be appropriately selected.

The present invention provides a textured vegetable protein comprising a protein blend and water, wherein the protein blend comprises legume-derived protein and high protein brewer's spent grain powder, and wherein the high protein brewer's spent grain powder has a total protein content (% dry matter by weight) of at least 25% based on the total weight of the high protein brewer's spent grain powder.

The present invention also provides a textured vegetable protein prepared by a process according to the present invention.

The total protein content of the textured vegetable protein according to the present invention (% dry matter by weight) is typically at least 50%, preferably at least 55%, and more preferably at least 60% (as determined by the Kjeldahl method using a conversion factor of 6.25). For example, the total protein content (% dry matter by weight) may be in the range of from 50% to 90%, for example 50, 55, 60, 65, 70, 75, 80, 85 or 90%, or any intermediate value.

The total dietary fibre content of the textured vegetable protein according to the present invention (% dry matter by weight) is typically at least 5%, for example at least 8%, at least 15%, at least 20%, at least 25%, at least 30%, or any intermediate value. For example, the total dietary fibre content (% dry matter by weight) may be in the range of from 5 to 25%, for example 5, 8, 10, 15, 20 or 25%, or any intermediate value.

The water content of the textured vegetable protein according to the present invention is typically from 2 to 10% by weight, for example 2, 3, 4, 5, 6, 7, 8, 9 or 10% by weight, or any intermediate value.

### Protein Blend:

The protein used to produce the textured vegetable protein according to the present invention is a protein blend comprising legume-derived protein and high protein brewer's spent grain powder.

The protein blend preferably comprises legume-derived protein in an amount of from 20 to 90% by weight (for example 20, 25, 30, 35, 40, 45, 50, 55, 60, 65, 70, 75, 80, 85 or 90% by weight, or any intermediate value), preferably from 40 to 90% by weight, based on the total weight of the protein blend. For example, the protein blend may comprise legume-derived protein in an amount of from 55 to 90% by weight, from 60 to 90% by weight, from 60 to 85% by weight, from 65 to 85%, from 70 to 85% or from 75 to 85% by weight, based on the total weight of the protein blend.

The protein blend preferably comprises high protein brewer's spent grain powder in an amount of from 10 to 80% by weight (for example 10, 15, 20, 25, 30, 35, 40, 45, 50, 55, 60, 65, 70, 75 or 80% by weight, or any intermediate value), preferably from 10 to 60% by weight, based on the total weight of the protein blend. For example, the protein blend may comprise high protein brewer's spent grain powder in an amount of from 10 to 45% by weight, from 10 to 40% by weight, from 15 to 40% by weight, from 15 to 35% by weight, from 15 to 30% by weight or from 15 to 25% by weight, based on the total weight of the protein blend.

In some embodiments, the protein blend may include additional protein components in addition to legume-derived protein and high protein brewer's spent grain powder. An example of an additional protein component that may be included in the protein blend is vital wheat gluten. Additional protein components, such as vital wheat gluten, may be present in an amount of up to 40% by weight, preferably from 10 to 40% by weight, preferably from 10 to 30% by weight, based on the total weight of the protein blend. For example, additional protein components, such as vital wheat gluten, may be present in an amount of 10, 15, 20, 25, 30, 35 or 40% by weight, or any intermediate value, based on the total weight of the protein blend.

In some embodiments, the protein blend may include a minor amount of non-protein components (for example, up to about 10% by weight based on the total weight of the protein blend, for example 1, 2, 3, 4, 5, 6, 7, 8, 9 or 10% by weight, including any intermediate value). Examples of suitable non-protein components include starches.

In some embodiments, the protein blend consists essentially of, or consists of, legume-derived protein and high protein brewer's spent grain powder.

It is an advantage of the present invention that the protein blend is able to act as a high quality, i.e. complete, source of protein, that is a protein source that contains an adequate proportion of the nine amino acids essential for the human diet in digestible form (i.e. histidine, isoleucine, leucine, lysine, methionine, phenylalanine, threonine, tryptophan, and valine).

Protein quality may be evaluated using Protein Digestibility-Corrected Amino Acid Score (PDCAAS), which is calculated according to the following formula:

$$PDCAAS ( \% ) = \frac{\begin{matrix}mg limiting amino acid \\ in 1 g text protein\end{matrix}}{\begin{matrix}mg same amino acid \\ in 1 g reference protein\end{matrix}} \times fecal digestibility \times 100 \%$$

The FAO (Food and Agriculture Organisation of the United Nations) provides the following reference protein for the older child, adolescent and adult (mg/g):

| | |
|---|---|
| Histidine | 16 |
| Isoleucine | 30 |
| Leucine | 61 |
| Lysine | 48 |
| Methionine + Cysteine | 23 |
| Phenylalanine + Tyrosine | 41 |
| Threonine | 25 |
| Tryptophan | 6.6 |
| Valine | 40 |

PDCAAS can be calculated for the protein blends used in the present invention using an assumed digestibility of 95%. The PDCAAS of the protein blend is preferably at least 0.7, preferably at least 0.8, preferably at least 0.9. Given that PDCAAS values are truncated to 1, the PDCAAS of the protein blend is preferably in the range of 0.7 to 1, preferably 0.8 to 1, preferably 0.9 to 1. In some embodiments, the PDCAAS of the protein blend is 1.

While soy bean protein is considered to be a high quality protein, other legume-derived proteins may be limited in terms of one of more essential amino acids. By way of example, the limiting amino acid in pea protein is methionine+cysteine. High protein brewer's spent grain powder is comparatively rich in these amino acids, and so is complementary in terms of its amino acid profile. This means that a protein blend comprising pea protein and high protein brewer's spent grain is a more complete protein than pea protein alone, and this is a particular advantage of embodiments of the present invention in which the legume-derived protein is pea protein (or another incomplete legume-derived protein).

### Legume-Derived Protein:

The legume-derived protein may be a protein derived from any legume such as, for example, beans, peas, chickpeas, lupins, lentils and/or peanuts. Protein derived from beans and/or peas is preferred, and soy bean protein and pea protein are particularly suitable for use in the present invention.

The legume-derived protein may be in the form of a protein concentrate and/or protein isolate. Soy bean protein concentrate, soy bean protein isolate, pea protein concentrate, and pea protein isolate are all particularly suitable for use in the present invention, and use of any of these individually or in any combination is contemplated. According to some embodiments, the legume-derived protein is a soy bean protein concentrate. According to some embodiments, the legume-derived protein is a soy bean protein isolate. According to some embodiments, the legume-derived protein is a pea protein isolate.

### High Protein Brewer's Spent Grain Powder:

The high protein brewer's spent grain powder is powdered brewer's spent grain, in particular a powdered brewer's spent grain fraction, having a total protein content (% dry matter by weight) of at least 25% (as determined by the Kjeldahl method using a conversion factor of 6.25), based on the total weight of the high protein brewer's spent grain powder.

According to some embodiments, the high protein brewer's spent grain powder has a total protein content (% dry matter by weight) of at least 26%, at least 27%, at least 28%, at least 29%, at least 30%, at least 31%, at least 32% or at least 33% (as determined by the Kjeldahl method using a conversion factor of 6.25), based on the total weight of the high protein brewer's spent grain powder.

A preferred high protein brewer's spent grain powder is powdered brewer's spent grain having a total protein content (% dry matter by weight) of at least 33% (as determined by the Kjeldahl method using a conversion factor of 6.25), and a total dietary fibre content of greater than 35% and below 55% (as determined by AOAC 991.43), based on the total weight of the high protein brewer's spent grain powder.

The high protein brewer's spent grain powder may be the “protein composition” according to WO 2021/028405, the entire content of which is incorporated herein by reference (in particular, all features of the “protein composition” according to WO 2021/028405, and of the process by which it is made, form a part of the present description of the high protein brewer's spent grain powder). A high protein brewer's spent grain powder suitable for use in the present invention is the commercially available product Evervita™ PRO (available from EverGrain LLC, IL, USA).

As set out in WO 2021/028405, a high protein brewer's spent grain powder can be prepared by a process comprising:
a) providing dried brewer's spent grain having a moisture content of 10% by weight or less;
b) micronising the dried brewer's spent grain using a pin mill to provide micronised brewer's spent grain;
c) fractionating the micronised brewer's spent grain using an air classifier to provide a coarse fraction and a fine fraction; and
d) collecting the coarse fraction to provide a fibre composition and collecting the fine fraction to provide the high protein brewer's spent grain powder.

The starting material for the above process is brewer's spent grain. Brewer's spent grain is a by-product of the brewing industry following the mashing step. At this point of the brewing process, the soluble fraction (known as ‘wort’) is taken forward for further brewing steps while the insoluble fraction is removed. This insoluble fraction is brewer's spent grain.

The brewer's spent grain used in the above process is preferably obtained after brewing with grains comprising barley and, optionally, one or more other grains or starchy materials such as rice, corn, sorghum and cassava, particularly rice and/or corn. The grains used for brewing (i.e. the grain mix used at the start of the brewing process) preferably comprise barley in an amount of at least 40% by weight (for example at least 40, 45, 50, 55, 60, 65 or 70% by weight, or any intermediate value), preferably at least 60% by weight, preferably at least 70% by weight, based on the total dry matter weight of the grains.

The brewer's spent grain used in the above process preferably has a total dietary fibre content (% dry matter by weight) of from 48% to less than 62%, preferably from 50% to less than 60% (for example 51, 52, 53, 54, 55, 56, 57, 58 or 59%, or any intermediate value), as determined by AOAC 991.43, and a total protein content (% dry matter by weight) of greater than 20% to less than 35%, preferably of greater than 25% to less than 35% (for example 26, 27, 28, 29, 30, 31, 32, 33 or 34%, or any intermediate value), as determined by the Kjeldahl method using a conversion factor of 6.25.

The high protein brewer's spent grain powder is preferably a high protein brewer's spent grain powder having the following features:
a particle size (d90) of between 20 and 200 μm, preferably between 40 and 130 μm, preferably between 50 and 130 μm, preferably between 50 and 100 μm, as determined by laser diffraction;
a total dietary fibre content (% dry matter by weight) of greater than 35% and below 55%, as determined by AOAC 991.43;
a total insoluble fibre content (% dry matter by weight) of between 30 and 60%, preferably between 35 and 50%, and a total soluble dietary fibre content (% dry matter by weight) of between 0 and 10%, preferably between 1 and 5%, as determined by AOAC 2011.25;
a total protein content (% dry matter by weight) of at least 33%, preferably between 33 and 50%, preferably between 35 and 40%, as determined by the Kjeldahl method using a conversion factor of 6.25; and, preferably a total combined content of protein and dietary fibre (% dry matter by weight) of between 80 and 100% and a ratio of protein to dietary fibre (dry matter by weight) of between 0.75 and 1.5, wherein the total dietary fibre content is determined by AOAC 991.43 and the total protein content is determined by the Kjeldahl method using a conversion factor of 6.25.

### Process for Preparing Textured Vegetable Protein:

The process of the present invention comprises extruding a mixture comprising a protein blend and water to produce a textured vegetable protein, that is extruding a mixture comprising a protein blend and water under conditions effective to produce a textured vegetable protein.

The process for preparing the textured vegetable protein according to the present invention is analogous to known processes for producing textured vegetable proteins. Such processes are well-known to those skilled in the art. In this regard, reference may be made, by way of example, to Chapter 15 (Texturized vegetable proteins) of the Handbook of Food Proteins (M. N. Riaz, Woodhead Publishing, 2011, Pages 395-418). As has already been described above, the conditions effective to produce a textured vegetable protein include a combination of high temperature, pressure and shear. These conditions restructure the vegetable protein to produce a fibrous, insoluble and porous protein network, which forms the basis for the texture of the final product. On exiting the extruder, a sudden drop in pressure causes rapid expansion, and this expanded product may then be dried to provide the textured vegetable protein.

The process according to the present invention may be described as low moisture extrusion cooking. For example, the extruding of the present invention may comprise adding the protein blend to the extrusion process in a total amount of from 60% to 85% by weight (for example 60, 65, 70, 75, 80 or 85%, or any intermediate value) and adding water to the extrusion process in an amount of from 15 to 40% by weight (for example 15, 20, 25, 30, 35 or 40%, or any intermediate value) based on the total weight of the mixture comprising the protein blend and water. Water may be added to the protein blend in a preconditioner and then added to the extruder together with the protein blend, or added to the extruder directly, or both.

As will be appreciated by those skilled in the art, water may be added to an extrusion process in liquid form, or as steam, or both. As such, references to “water” in the context of the extrusion process include liquid water, steam, or both.

The extruder used in the present invention is preferably a twin-screw extruder.

In some embodiments, the extruding of the present invention comprises the following steps:
a) forming a mixture comprising the protein blend and water;
b) heating the mixture to above the denaturation temperature of the proteins present in the mixture;
c) applying shear and pressure to the mixture in an extruder to form a fibrous protein network;
d) forcing the mixture through a die to form the textured vegetable protein;
e) optionally, cutting the textured vegetable protein; and
f) optionally, drying the textured vegetable protein.

As will be appreciated by those skilled in the art, specific extrusion parameters used to obtain a given product (such as barrel temperature, screw speed, die temperature and the like) can vary according to scale. A scale-independent measure of the mechanical energy put into an extrudate is specific mechanical energy (SME). The term “specific mechanical energy” is well known in the art, and may be calculated according to the following equation:

$$SME = \frac{Drive Power [ W ]}{Throughput [ kg / h ]}$$

Modern extruders typically calculate and display SME values.

According to the present invention, a specific mechanical energy (SME) of at least 50 W*h/kg is typically applied to the mixture in the extruder. For example, an SME of 50, 55, 60, 65, 70, 75, 80, 85, 90, 95, 100, 105, 110, 115, 120, 125, 130, 135, 140, 145 or 150 W*h/kg, or any intermediate value, may be applied.

In the process steps set out above, the steps a) and b) may be conducted in the extruder, or in a preconditioner, or in a combination of the preconditioner and the extruder. Where a preconditioner is used, step a) will typically take place primarily in the preconditioner and step b) will typically take place primarily in the extruder.

The addition of water (as liquid water, as steam, or both) to the process (i.e. to the mixture) takes place in step a), and may additionally take place in steps b) and/or c).

### Hydrated Textured Vegetable Protein and Meat Analogue:

The present invention further provides hydrated textured vegetable protein, wherein the textured vegetable protein is the textured vegetable protein according to the present invention.

As discussed above, the textured vegetable protein according to the present invention preferably has a water content (i.e. moisture content) of from 2 to 10% by weight; this form is suitable for transport and long term storage, but is not generally eaten as such.

The hydrated textured vegetable protein according to the present invention is prepared by hydrating the textured vegetable protein according to the present invention. Following hydration, the hydrated textured vegetable protein preferably has a water content (i.e. moisture content) of from 40 to 80% by weight (for example 40, 45, 50, 55, 60, 65, 70, 75 or 80% by weight, including all intermediate values), preferably from 60 to 80% by weight.

The hydrated textured vegetable protein according to the present invention may be used as a meat analogue. As such, the present invention further provides a meat analogue comprising the hydrated textured vegetable protein according to the present invention.

The meat analogue according to the present invention may comprise one or more further ingredients. Further ingredients may include one or more ingredients selected from the group consisting of binders, seasonings, herbs, spices, fats, natural and/or synthetic sweeteners, natural and/or synthetic flavourings, and natural and/or synthetic preservatives.

Binders suitable for use in the meat analogue according to the present invention include hydrocolloids, starches, proteins and the like. Particular examples include starches such as potato starch and corn starch; flours such as rice flour; fibers such as bamboo fiber, psyllium fiber and cellulose derivatives; and brewer's spent grain powder, including the high protein brewer's spent grain powder as described herein.

In certain embodiments, the one or more further ingredients may include one or more ingredients of animal origin. For example, flavourings may include meat extracts or other flavourings derived from meat.

According to preferred embodiments, the meat analogue does not include any ingredients of animal origin, and is preferably suitable for plant-based or vegan diets.

Further ingredients may be incorporated in the meat analogue according to the present invention by being included as a component of an aqueous solution or suspension in which the textured vegetable protein according to the present invention is hydrated, and/or by being combined with the hydrated textured vegetable protein following hydration. It will often be convenient to include any water-soluble further ingredients in an aqueous solution in which the textured vegetable protein according to the present invention is hydrated, and to combine any non-water-soluble further ingredients (including, e.g., oils or oil-based ingredients) with the hydrated textured vegetable protein following hydration.

The meat analogue according to the present invention may be particularly suitable as an analogue to ground or minced meat, for example ground or minced beef, pork, chicken or lamb.

The meat analogue according to the present invention has been found to have a number of advantageous properties compared to known meat analogues based on textured vegetable protein. These include having a more meat-like (i.e. darker brown) appearance without the need for additional colouring agents and a more meat-like “chew”. These advantageous properties can be achieved according to the present invention at the same time as providing a high quality (i.e. complete) source of protein.

### Food Products:

The present invention further provides a food product comprising the meat analogue according to the present invention.

Food products according to the present invention include food products is selected from the group consisting of burgers, sausages, meat balls, nuggets, pizza toppings, sauces, stews, and jerky.

According to some embodiments, the food products according to the present invention may comprise meat. In such embodiments, the meat analogue according to the present invention is acting as a “meat extender” rather than a complete meat replacement. Meat extenders are useful as a means for reducing meat consumption, and are attractive to consumers who wish to reduce, rather than completely eliminate, meat from their diets.

According to other embodiments, the food products according to the present invention do not comprise meat or any ingredient of animal origin, and are thus suitable as a part of a plant-based or vegan diet.

### EXAMPLES

The present invention will now be further illustrated with reference to the following examples. The present invention is in no way limited to the given examples or to the embodiments presented in the figures.

### Equipment:

All textured vegetable protein samples were prepared using a twin screw co-rotating extruder (CLEXTRAL™ EV-32, CLEXTRAL, France) fitted with a preconditioner. Samples were dried using a belt dryer at ˜86-87° C. for ˜67 minutes.

### Materials:

The following materials were used in the Examples:

| Material | Product | Supplier |
|---|---|---|
| Soy protein isolate | Profam ™ 981-SPI | Archer-Daniels-Midland Company |
| | | (IL, USA) |
| Soy protein concentrate | Arcon ™ S | Archer-Daniels-Midland Company |
| | | (IL, USA) |
| Pea protein isolate | Pea Protein YS 85% | The Scoular Company (NE, USA) |
| High protein brewer's | Evervita ™ PRO | EverGrain, LLC (IL, USA) |
| spent grain powder | | |

### Example 1

Textured vegetable protein was prepared with protein blends comprising soy protein and high protein brewer's spent grain powder. The protein blends and the extrusion parameters are provided below.

### Protein Blonds (Amounts in Weight %):

| | Example | | | | | |
|---|---|---|---|---|---|---|
| | 1A | | | | | |
| Protein | (comparative) | 1B | 1C | 1D | 1E | 1F |
| Soy protein | 100% | 80% | 70% | 60% | 85% | 0% |
| concentrate | | | | | | |
| Soy protein isolate | 0% | 0% | 0% | 0% | 0% | 80% |
| High protein | 0% | 20% | 30% | 40% | 15% | 20% |
| brewer's spent | | | | | | |
| grain powder | | | | | | |

### Extrusion Parameters:

| | Example | | | | | |
|---|---|---|---|---|---|---|
| | 1A | | | | | |
| Parameter | (comparative) | 1B | 1C | 1D | 1E | 1F |
| Feed rate (kg/hr) | 30.7 | 30.4 | 30.1 | 29.5 | 35.4 | 32.0 |
| Water flow (kg/hr) | 9.4 | 10.1 | 5.6 | 2.0 | 5.1 | 7.1 |
| Total Moisture (%) | 37.8 | 38.6 | 33.0 | 27.7 | 30.2 | 33.4 |
| Barrel Zone 1 (° C.) | 60 | 60 | 60 | 60 | 60 | 60 |
| Barrel Zone 2 (° C.) | 90 | 90 | 90 | 90 | 90 | 90 |
| Barrel Zone 3 (° C.) | 110 | 135 | 125 | 115 | 115 | 115 |
| Barrel Zone 4 (° C.) | 118 | 155 | 140 | 130 | 135 | 135 |
| Barrel Zone 5 (° C.) | 118 | 155 | 140 | 130 | 135 | 135 |
| Barrel Zone 6 (° C.) | 118 | 155 | 140 | 130 | 135 | 135 |
| Die Temperature (° C.) | 99 | 141 | 140 | 131 | 134 | 135 |
| SME (Watt*h/Kg) | 79.8 | 64.6 | 75.8 | 83.8 | 79.7 | 82.1 |
| Screw speed (rpm) | 372 | 446 | 446 | 446 | 446 | 446 |
| Cutter speed (rpm) | 551 | 551 | 551 | 551 | 551 | 551 |
| Steam Flow (kg/hr) | 12.0 | 12.0 | 12.0 | 12.0 | 12.0 | 12.0 |
| Water flow to | 0 | 0 | 0 | 0 | 0 | 0 |
| preconditioner (kg/hr) | | | | | | |
| Preconditioner | 125 | 125 | 125 | 125 | 125 | 125 |
| speed (rpm) | | | | | | |
| Moisture content (%) | 9.53 | 5.87 | 4.75 | 3.43 | 5.64 | 3.70 |

A functional analysis of the textured vegetable protein was carried out and the results wore as follows:

| | Example | | | | | |
|---|---|---|---|---|---|---|
| | 1A | | | | | |
| Test | (comparative) | 1B | 1C | 1D | 1E | 1F |
| Colour L | 67.33 | 66.61 | 64.51 | 61.50 | 63.81 | 65.73 |
| Colour a | 4.87 | 6.33 | 7.23 | 7.72 | 7.59 | 6.89 |
| Colour b | 21.50 | 19.14 | 19.70 | 19.17 | 19.97 | 19.44 |
| Moisture | 10.86 | 5.49 | 3.71 | 2.51 | 4.16 | 2.98 |
| Content (%) | | | | | | |
| Bulk Density (g/L) | 192.9 | 182.2 | 248.3 | 352.3 | 169.2 | 163.1 |
| Water Holding | 5.83 | 4.96 | 3.26 | 2.89 | 4.60 | 4.18 |
| Capacity (g | | | | | | |
| water per | | | | | | |
| Hardness (N) | 9.35 | 5.72 | 7.53 | 8.68 | 7.46 | 8.65 |
| Adhesiveness (mJ) | 0.00 | 0.00 | 0.01 | 0.01 | 0.01 | 0.01 |
| Springiness | 0.95 | 0.95 | 0.93 | 0.91 | 0.95 | 0.95 |
| Chewiness (mJ) | 47.78 | 27.51 | 34.88 | 31.79 | 39.44 | 46.38 |

The textured vegetable protein was hydrated in water and the water absorption index of each sample is shown below [water absorption index=(rehydrated weight−original weight)/original weight]:

| | Example | | | | | |
|---|---|---|---|---|---|---|
| | 1A | | | | | |
| | (comparative) | 1B | 1C | 1D | 1E | 1F |
| Water absorption | 3.17 | 3.49 | 2.66 | 2.38 | 3.16 | 2.75 |
| index (%) | | | | | | |

The characteristics of the hydrated textured vegetable protein and suitability for use in example food applications were assessed. The hydrated textured vegetable protein according to the present invention (1B-1F) was found to have a desirable natural brown colour and good mouthfeel. Further results of the assessment are shown below.

| | | Example |
|---|---|---|
| Example | Characteristics | Applications |
| 1A | Spongy and porous, light colour | |
| (comparative) | | |
| 1B | Chewy texture with short fibration, | Pizza toppings |
| | neutral taste, brown in colour, | |
| | irregular in shape | |
| 1C | Chewier texture than 1B, mild | Beef burgers |
| | aftertaste, brown in colour | |
| 1D | Smallest cut, pronounced aftertaste, | Ground beef |
| | smaller cut size, dark brown in | |
| | colour | |
| 1E | Better fibration and not as porous | Pizza toppings |
| | and spongy compared to 1A | |
| 1F | Similar texture and flavour to 1E, | Jerky, stews |
| | firm and good fibration, irregular | |
| | shape and big pieces, brown in | |
| | colour | |

### Example 2

Textured vegetable protein was prepared with protein blends comprising pea protein and high protein brewer's spent grain powder. The protein blends and the extrusion parameters are provided below:

### Protein Blends (Amounts in Weight %):

| | Example | | | | |
|---|---|---|---|---|---|
| | 2A | | | | |
| Protein | (comparative) | 2B | 2C | 2D | 2E |
| Pea protein isolate | 100% | 80% | 80% | 70% | 70% |
| High protein brewer's | 0% | 20% | 20% | 30% | 30% |
| spent grain powder | | | | | |

### Extrusion Parameters:

| | Example | | | | |
|---|---|---|---|---|---|
| | 2A | | | | |
| Parameter | (comparative) | 2B | 2C | 2D | 2E |
| Feed rate (kg/hr) | 30.4 | 29.8 | 29.8 | 31.1 | 31.1 |
| Water flow (kg/hr) | 4.6 | 4.6 | 4.6 | 2.9 | 2.9 |
| Total Moisture (%) | 30.6 | 31.6 | 31.6 | 27.8 | 27.8 |
| Barrel Zone 1 (° C.) | 50 | 50 | 50 | 50 | 50 |
| Barrel Zone 2 (° C.) | 80 | 80 | 80 | 80 | 80 |
| Barrel Zone 3 (° C.) | 165 | 165 | 165 | 135 | 135 |
| Barrel Zone 4 (° C.) | 165 | 165 | 165 | 165 | 165 |
| Barrel Zone 5 (° C.) | 165 | 165 | 165 | 165 | 165 |
| Barrel Zone 6 (° C.) | 165 | 165 | 165 | 165 | 165 |
| Die Temperature | 168 | 173 | 173 | 154 | 154 |
| (° C.) | | | | | |
| SME (Watt*h/Kg) | 34.3 | 44.7 | 44.7 | 50.2 | 50.2 |
| Screw speed (rpm) | 495 | 495 | 495 | 495 | 495 |
| Cutter speed (rpm) | 551.7 | 551.7 | 3350 | 551 | 3378 |
| Steam Flow (kg/hr) | 10.1 | 10.2 | 10.2 | 10 | 10 |
| Water flow to | 0 | 0 | 0 | 0 | 0 |
| preconditioner | | | | | |
| (kg/hr) | | | | | |
| Preconditioner | 123.7 | 123.9 | 123.9 | 124 | 124 |
| speed (rpm) | | | | | |

A functional analysis of the textured vegetable protein was carried out and the results were as follows:

| | Example | | | | |
|---|---|---|---|---|---|
| | 2A | | | | |
| Test | (comparative) | 2B | 2C | 2D | 2E |
| Colour L | 68.73 | 63.62 | 63.61 | 61.76 | 61.22 |
| Colour a | 6.46 | 6.17 | 5.88 | 6.83 | 6.48 |
| Colour b | 21.09 | 19.02 | 18.80 | 19.41 | 18.81 |
| Moisture | 5.44 | 5.00 | 6.70 | 4.37 | 5.83 |
| Content (%) | | | | | |
| Bulk Density | 93.85 | 138.60 | 176.10 | 136.35 | 177.55 |
| (g/L) | | | | | |
| Water Holding | 5.85 | 2.81 | 1.77 | 2.36 | 2.37 |
| Capacity (g | | | | | |
| water per | | | | | |
| Hardness (N) | 6.98 | 7.53 | 7.76 | 7.8 | 10.18 |
| Adhesiveness | 0.01 | 0.03 | 0 | 0.02 | 0.01 |
| (mJ) | | | | | |
| Springiness | 0.97 | 0.95 | 0.94 | 0.94 | 0.92 |
| Chewiness (mJ) | 40.32 | 41.67 | 35.71 | 37.06 | 44.02 |

The textured vegetable protein was hydrated in water and the water absorption index of each sample is shown below:

| | Example | | | | |
|---|---|---|---|---|---|
| | 2A | | | | |
| | (comparative) | 2B | 2C | 2D | 2E |
| Water absorption index | 6.72 | 2.50 | 2.39 | 2.20 | 2.21 |
| (%) | | | | | |

The characteristics of the hydrated textured vegetable protein and suitability for use in example food applications were assessed. The hydrated textured vegetable protein according to the present invention (2B-2D) was found to have a desirable natural brown colour and good mouthfeel. Further results of the assessment are shown below.

| | | Example |
|---|---|---|
| Example | Characteristics | Applications |
| 2A | Irregular cut size; hydrated size | |
| (comparative) | ~20-27 mm; light brown colour; | |
| | expanded, large bubble, spongy; no | |
| | beany aftertaste; good meat-like bite | |
| 2B | Irregular cut size; hydrated size | Pizza topping, |
| | ~15-18 mm; grey/brown colour; | cooked beef or |
| | solid/tight structure; no beany | pork crumbles |
| | aftertaste; firmer bite than 2A | |
| 2C | Uniform small cut size; hydrated | Tacos |
| | size ~8-10 mm; similar taste and | |
| | texture to 2B | |
| 2D | Irregular curly cut size; hydrated | Tacos, beef |
| | size ~12-14 mm; darker brown | burgers, cooked |
| | colour than 2B and 2C; smaller and | beef crumbles |
| | tighter structure than 2B and 2C; | |
| | mild aftertaste; firm bite | |
| 2E | Smaller cut size, not as curly; | Tacos, beef |
| | hydrated size ~9-7 mm; similar | burgers, meatballs |
| | taste and texture to 2D | |

### Example 3

Vegan grounds were prepared using the textured vegetable protein of Examples 1C and 1D according to the following recipes:

| | Example (amounts are % by weight) | | |
|---|---|---|---|
| Ingredients | 3A | 3B | 3C |
| Textured vegetable protein | 24.92 | | 12.46 |
| of Ex. 1C | | | |
| Textured vegetable protein | | 24.92 | 12.46 |
| of Ex. 1D | | | |
| Water (tap) | 70.26 | 70.26 | 70.26 |
| Beef flavour, liquid (Windsor) | 0.52 | 0.52 | 0.52 |
| Natural umami flavour | 0.31 | 0.31 | 0.31 |
| (Firmenich) | | | |
| Cane sugar | 0.36 | 0.36 | 0.36 |
| Salt | 0.52 | 0.52 | 0.52 |
| Canola oil | 3.11 | 3.10 | 3.10 |
| Total | 100.00 | 100.00 | 100.00 |

The umami flavour, sugar and salt were combined, added to water and stirred to dissolve. The textured vegetable protein was added and allowed to hydrate for 15 to 20 minutes. The beef flavour and canola oil were then stirred in and evenly mixed before packaging and sealing.

The characteristics of the vegan grounds 3A-D are summarised below:
3A: Light brown colour, larger-sized pieces, mild roasted barley aroma, earthy and meaty flavour, good meat-like texture and bite.
3B: Dark brown colour, smaller-sized pieces, stronger roasted barley aroma, earthy and meaty flavour, softer chew due to smaller-sized pieces
3C: Intermediate properties between those of 3A and 3B

### Example 4

Precooked vegan crumbles were prepared using the textured vegetable protein of Examples 1B and 1C according to the following recipes:

| | Example (amounts are % by weight) | | | |
|---|---|---|---|---|
| Ingredients | 4A | 4B | 4C | 4D |
| Textured vegetable | 22.92 | | 19.45 | |
| protein of Ex. 1B | | | | |
| Textured vegetable | | 22.92 | | 19.45 |
| protein of Ex. 1C | | | | |
| High protein brewer's | 2.00 | 2.00 | 4.00 | 4.00 |
| spent grain powder | | | | |
| Mild Italian seasoning | 7.89 | 7.89 | 7.89 | 7.89 |
| (Griffith Foods) | | | | |
| Water (tap) | 63.48 | 63.48 | 62.35 | 62.35 |
| Beef flavour, liquid | 0.55 | 0.55 | 0.55 | 0.55 |
| (Firmenich) | | | | |
| Natural umami flavour | 0.31 | 0.31 | 0.31 | 0.31 |
| (Firmenich) | | | | |
| Masking for vegetable | 0.25 | 0.25 | 0.25 | 0.25 |
| protein (Firmenich) | | | | |
| Canola oil | 2.60 | 2.60 | 5.20 | 5.20 |
| Total | 100.00 | 100.00 | 100.00 | 100.00 |

The umami flavour, mild Italian seasoning and masking for vegetable protein were combined, added to water and stirred to dissolve. The textured vegetable protein was added and allowed to hydrate for 15 to 20 minutes. The beef flavour, canola oil and high protein brewer's spent grain powder were then stirred in and evenly mixed. The resulting crumbles were then cooked in oil in a pan over medium heat for 5-8 minutes before being quick-frozen to −18° C. and packaged.

The characteristics of the precooked vegan crumbles 4A-4D are summarised below:
4A: Light brown in colour, very pleasant Italian spice taste with malt-like flavour note at the end, easy to cook with small amount of oil and no sticking to the pan.
4B: Slightly dark brown in colour, very pleasant Italian spice taste with malt-like flavour note at the end, easy to cook with small amount of oil and no sticking to the pan.
4C: Slightly dark brown in colour, more prominent malt/roasted barley taste followed by Italian spice flavour, a little more oil required for cooking to prevent sticking.
4D: Dark brown in colour, more prominent malt/roasted barley taste followed by Italian spice flavour, a little more oil required for cooking to prevent sticking.

### Example 5

Vegan grounds were prepared using the textured vegetable protein of Comparative Example 2A and Examples 2C and 2E according to the following recipes:

| | Example (amounts are % by weight) | | |
|---|---|---|---|
| | 5A | | |
| Ingredients | (Comparative) | 5B | 5C |
| Textured vegetable protein | 24.92 | | |
| of Comp. Ex. 2A | | | |
| Textured vegetable protein | | 24.92 | |
| of Ex. 2C | | | |
| Textured vegetable protein | | | 24.92 |
| of Ex. 2E | | | |
| Water (tap) | 69.75 | 69.75 | 69.75 |
| Beef flavour, liquid (Firmenich) | 0.52 | 0.52 | 0.52 |
| Natural umami flavour (Firmenich) | 0.31 | 0.31 | 0.31 |
| Cane sugar | 0.36 | 0.36 | 0.36 |
| Salt | 0.52 | 0.52 | 0.52 |
| Canola oil | 3.11 | 3.10 | 3.10 |
| Total | 100.00 | 100.00 | 100.00 |

The umami flavour, sugar and salt were combined, added to water and stirred to dissolve. The textured vegetable protein was added and allowed to hydrate for 15 to 20 minutes. The beef flavour and canola oil were then stirred in and evenly mixed before packaging and sealing.

The characteristics of the vegan grounds 5A-C are summarised below:
5A (Comparative): Light brown colour, chewy and tough texture, mild pea taste at the end
5B: Dark brown colour, softer and more tender bite compared to 5A, mild roasted barley aroma, meaty flavour with mild bitter note at the end, no detectable pea taste
5C: Medium/dark brown colour, firmer meat-like bite and texture, mild roasted barley aroma, meaty flavour with bitter note at the end, no detectable pea taste

### Example 6

Precooked vegan crumbles were prepared using the textured vegetable protein of Comparative Example 2A and Examples 2B and 2D according to the following recipes:

| | Example (amounts are % by weight) | | |
|---|---|---|---|
| | 6A | | |
| Ingredients | (Comparative) | 6B | 6C |
| Textured vegetable protein | 25.79 | | |
| of Comp. Ex. 2A | | | |
| Textured vegetable protein | | 25.79 | |
| of Ex. 2B | | | |
| Textured vegetable protein | | | 25.79 |
| of Ex. 2D | | | |
| High protein brewer's spent | | 2.0 | 2.0 |
| grain powder | | | |
| Rice flour | 2.0 | | |
| Spice blend* | 3.50 | 3.50 | 3.50 |
| Water (tap) | 64.50 | 64.50 | 64.50 |
| Beef flavour, liquid (Firmenich) | 0.55 | 0.55 | 0.55 |
| Natural umami flavour (Firmenich) | 0.31 | 0.31 | 0.31 |
| Masking for vegetable protein | 0.50 | 0.50 | 0.50 |
| (Firmenich) | | | |
| Salt | 0.50 | 0.50 | 0.50 |
| Canola oil | 2.60 | 2.60 | 5.20 |
| Total | 100.00 | 100.00 | 100.00 |

*Spice blend (wt %): Salt (26.86), paprika (16.29), garlic powder (8.00), onion powder (5.71), red pepper flakes (14.57), white pepper (4.86), black pepper (4.00), mustard powder (0.29), dried sweet basil (4.00), dried oregano (4.57), dried rosemary (1.71), dried marjoram (2.00), dried cilantro/coriander (3.14), dried thyme (4.00)

The umami flavour, spice blend and masking for vegetable protein were combined, added to water and stirred to dissolve. The textured vegetable protein was added and allowed to hydrate for 15 to 20 minutes. The beef flavour, canola oil and high protein brewer's spent grain powder (or rice powder) were then stirred in and evenly mixed. The resulting crumbles were then cooked in oil in a pan over medium heat for 5-8 minutes before being quick-frozen to −18° C. and packaged.

The characteristics of the precooked vegan crumbles 6A-6C are summarised below:
6A (Comparative): Light brown in colour, very pleasant Italian spice taste, glassy appearance with large bubble cell structure, spongy, soft and chewy texture, easy to cook with small amount of oil and no sticking to the pan.
6B: Slightly dark brown in colour, very good Italian spice taste with mild bitter malt-like flavour note at the end, slightly spongy and fibrous cell structure, firm meat-like bite, easy to cook with small amount of oil and no sticking to the pan.
6C: Slightly dark brown in colour, mild bitter aftertaste, spongy and fibrous cell structure, firm meat-like bite, easy to cook with small amount of oil and no sticking to the pan.

### Example 7

A panel tasting session was carried out with a panel of seven tasters. The following samples were tasted:

| | |
|---|---|
| Sample 7A | Vegan crumbles of Example 4B |
| Sample 7B | Vegan crumbles of Example 4D |
| Sample 7C | Vegan grounds of Example 3B |
| Sample 7D (Comparative) | Commercial leading brand |

Tasters drank water between samples. The results are shown below (love it (9); neither like or dislike (5); hate it (1)):

| | | | | |
|---|---|---|---|---|
| | | | | 7D |
| Sample | 7A | 7B | 7C | (Comparative) |

A. Appearance (1 to 9)

| | | | | |
|---|---|---|---|---|
| General Appearance: | 6.1 | 5.5 | 8.1 | 4.1 |

B. Texture (1 to 9)

| | | | | |
|---|---|---|---|---|
| General texture: | 6.0 | 5.9 | 6.9 | 5.1 |

C. Aroma (1 to 9)

| | | | | |
|---|---|---|---|---|
| General Aroma: | 6.1 | 6.6 | 4.5 | 4.6 |

D. Taste (1 to 9)

| | | | | |
|---|---|---|---|---|
| General Flavour: | 6.4 | 6.1 | 4.1 | 4.4 |
| Are you willing to buy | 0.625 | 0.625 | 0.125 | 0.125 |
| this meat alternative? | | | | |
| No = 0 Yes = 1 | | | | |

The following general comments were recorded:

| Sample | Comments |
|---|---|
| 7A | Appearance and texture ok - good bite - quite spicy |
| 7B | Appearance and texture ok - good bite - quite spicy |
| 7C | Great appearance and texture - looks just like minced |
| | meat - taste more bland |
| 7D | No nice appearance - greyish - irregular shapes - dry, |
| (Comparative) | harder texture - strong taste of herbs |

### Example 8

A panel tasting session was carried out with a panel of seven tasters. The following samples were tasted:

| | |
|---|---|
| Sample 8A | Vegan crumbles of Comparative Example 6A |
| (Comparative) | |
| Sample 8B | Vegan crumbles of Example 6C |
| Sample 8C | Vegan grounds of Comparative Example 5A |
| (Comparative) | |
| Sample 8D | Vegan grounds of Example 5C |

Tasters drank water between samples. The results are shown below (love it (9); neither like or dislike (5); hate it (1)):

| | | | | |
|---|---|---|---|---|
| | 8A | | 8C | |
| Sample | (Comparative) | 8B | (Comparative) | 8D |

A. Appearance (1 to 9)

| | | | | |
|---|---|---|---|---|
| General Appearance: | 7.0 | 7.8 | 5.0 | 5.8 |

B. Texture (1 to 9)

| | | | | |
|---|---|---|---|---|
| General texture: | 3.0 | 6.6 | 5.4 | 6.4 |

C. Aroma (1 to 9)

| | | | | |
|---|---|---|---|---|
| General Aroma: | 5.7 | 6.8 | 4.8 | 4.8 |

D. Taste (1 to 9)

| | | | | |
|---|---|---|---|---|
| General Flavour: | 6.8 | 7.5 | 4.2 | 4.8 |
| Are you willing to buy | 0.75 | 1 | 0.25 | 0.67 |
| this meat alternative? | | | | |
| No = 0 Yes = 1 | | | | |

The following general comments were recorded:

| Sample | Comments |
|---|---|
| 8A (Comparative) | Spongy, airy, too fluffy, nice spicy taste |
| 8B | Quite dry/powdery, good texture, spicy |
| 8C (Comparative) | Spongy, looks like soggy bread crumbs, beany notes |
| 8D | Looks like minced meat, very good base product to |
| | be used in different formulations, some slight |
| | earthy notes, no beany notes |

1. A process for preparing a textured vegetable protein, wherein the process comprises extruding a mixture comprising a protein blend and water to produce a textured vegetable protein, wherein the protein blend comprises legume-derived protein and high protein brewer's spent grain powder, and wherein the high protein brewer's spent grain powder has a total protein content (% dry matter by weight) of at least 25% based on the total weight of the high protein brewer's spent grain powder.

2. The process according to claim 1, wherein the mixture comprising the protein blend and water has a total protein content (% dry matter by weight) of at least 50%, preferably at least 55%, preferably at least 60%.

3. The process according to claim 1 or 2, wherein the mixture comprising the protein blend and water has a total dietary fibre content (% dry matter by weight) of at least 5%, preferably at least 8%.

4. The process according to any of claims 1 to 3, wherein the mixture comprising the protein blend and water consists essentially of, or consists of, the protein blend and water.

5. The process according to any preceding claim, wherein the high protein brewer's spent grain powder has a total protein content (% dry matter by weight) of at least 30% based on the total weight of the high protein brewer's spent grain powder.

6. The process according to any preceding claim, wherein the high protein brewer's spent grain powder has a total protein content (% dry matter by weight) of at least 33%, and a total dietary fibre content (% dry matter by weight) of greater than 35% and below 55%, based on the total weight of the high protein brewer's spent grain powder.

7. The process according to any preceding claim, wherein the legume-derived protein is a legume protein concentrate or a legume protein isolate.

8. The process according to any preceding claim, wherein the protein blend comprises legume-derived protein in an amount of from 20 to 90% by weight, preferably from 40 to 90% by weight, based on the total weight of the protein blend.

9. The process according to claim 8, wherein the protein blend comprises legume-derived protein in an amount of from 55 to 90% by weight, preferably from 60 to 85% by weight, preferably from 75 to 85% by weight, based on the total weight of the protein blend.

10. The process according to any preceding claim, wherein the protein blend comprises high protein brewer's spent grain powder in an amount of from 10 to 80% by weight, preferably from 10 to 60% by weight, based on the total weight of the protein blend.

11. The process according to claim 10, wherein the protein blend comprises high protein brewer's spent grain powder in an amount of from 10 to 45% by weight, preferably from 15 to 40% by weight, preferably from 15 to 25% by weight, based on the total weight of the protein blend.

12. The process according to any preceding claim, wherein the legume-derived protein is protein derived from one or more of beans, peas, chickpeas, lupins, lentils and peanuts, and is preferably derived from beans and/or peas.

13. The process according to claim 12, wherein the legume-derived protein is soy bean protein, pea protein, or a mixture of soy bean protein and pea protein.

14. The process according to claim 13, wherein the soy bean protein is a soy bean protein concentrate and/or wherein the pea protein is a pea protein isolate.

15. The process according to any preceding claim, wherein the protein blend further comprises vital wheat gluten.

16. The process according to claim 15, wherein the protein blend comprises vital wheat gluten in an amount of up to 40% by weight, preferably from 10 to 40% by weight, preferably from 10 to 30% by weight, based on the total weight of the protein blend.

17. The process according to any preceding claim, wherein the protein blend has a Protein Digestibility Corrected Amino Acid Score (PDCAAS) of at least 0.7, preferably at least 0.8, preferably at least 0.9.

18. The process according to any preceding claim, wherein the textured vegetable protein has a water content of from 2 to 10% by weight.

19. The process according to any preceding claim, wherein the extruding comprises low moisture extrusion cooking in an extruder.

20. The process according to claim 19, wherein the extruder is a twin-screw extruder.

21. The process according to any preceding claim, wherein the extruding is carried out in an extruder under conditions of high temperature, pressure and shear effective to restructure protein and produce a fibrous, insoluble and porous protein network.

22. The process according to any preceding claim, wherein the extruding comprises the following steps:
a) forming a mixture comprising the protein blend and water;
b) heating the mixture to above the denaturation temperature of the proteins present in the mixture;
c) applying shear and pressure to the mixture in an extruder to form a fibrous protein network;
d) forcing the mixture through a die to form the textured vegetable protein;
e) optionally, cutting the textured vegetable protein; and
f) optionally, drying the textured vegetable protein.

23. The process according to any of claims 19 to 22, wherein a specific mechanical energy (SME) of at least 50 W*h/kg is applied to the mixture in the extruder.

24. The process according to claim 22 or 23, wherein steps a) and b) are conducted in the extruder, in a preconditioner, or in a combination of the preconditioner and the extruder.

25. The process according to any of claims 22 to 24, wherein water is added to the mixture in step a) and in steps b) and/or c).

26. The process according to any preceding claim, wherein the extruding comprises adding the protein blend in a total amount of from 60% to 85% by weight and adding water in a total amount of from 15 to 40% by weight based on the total weight of the mixture comprising the protein blend and water.

27. A textured vegetable protein comprising a protein blend and water, wherein the protein blend comprises legume-derived protein and high protein brewer's spent grain powder, and wherein the high protein brewer's spent grain powder has a total protein content (% dry matter by weight) of at least 25% based on the total weight of the high protein brewer's spent grain powder.

28. The textured vegetable protein according to claim 27, wherein the protein blend is a protein blend as defined in any one of claims 5 to 17.

29. A textured vegetable protein prepared by a process according to any one of claims 1 to 26.

30. The textured vegetable protein according to any one of claims 27 to 29, wherein the textured vegetable protein has a total protein content (% dry matter by weight) of at least 50%, preferably at least 55%, more preferably at least 60%.

31. The textured vegetable protein according to any one of claims 27 to 30, wherein the textured vegetable protein has a total dietary fibre content (% dry matter by weight) of at least 5%, preferably at least 8%.

32. The textured vegetable protein according to any one of claims 27 to 31, wherein the textured vegetable protein has a water content of from 2 to 10% by weight.

33. A hydrated textured vegetable protein, wherein the textured vegetable protein is the textured vegetable protein according to any one of claims 27 to 32.

34. The hydrated textured vegetable protein according to claim 33, wherein the hydrated textured vegetable protein has a water content of from 40 to 80%, preferably from 60 to 80% by weight.

35. A meat analogue comprising the hydrated textured vegetable protein according to claim 33 or 34.

36. The meat analogue according to claim 35, wherein the meat analogue further comprises one or more ingredients of animal origin.

37. The meat analogue according to claim 35, wherein the meat analogue does not include any ingredients of animal origin.

38. The meat analogue according to any one of claims 35 to 37, wherein the meat analogue further comprises one or more further ingredients selected from the group consisting of binders, seasonings, herbs, spices, fats, natural and/or synthetic sweeteners, natural and/or synthetic flavourings, and natural and/or synthetic preservatives.

39. The meat analogue according to any one of claims 35 to 38, wherein the meat analogue is a ground meat analogue.

40. A process for preparing a meat analogue, comprising hydrating a textured vegetable protein according to any one of claims 27 to 32 to provide a hydrated textured vegetable protein and, optionally, combining the hydrated textured vegetable protein with one or more ingredients of animal origin and/or with one or more further ingredients as defined in claim 38.

41. The process according to claim 40, wherein the textured vegetable protein is hydrated in an aqueous solution or suspension comprising one or more further ingredients as defined in claim 38.

42. A food product comprising a meat analogue according to any one of claims 35 to 39.

43. The food product according to claim 42, wherein the food product is selected from the group consisting of burgers, sausages, meat balls, nuggets, pizza toppings, sauces, stews, and jerky.

44. The food product according to claim 42 or claim 43, wherein the food product comprises meat and the meat analogue acts as a meat extender.

45. The food product according to claim 42 or claim 43, wherein the food product does not include any ingredients of animal origin.
